(19) United States
(12) Patent Application Publication
(10) Pub. No.: US 2009/0171029 A1
(43) Pub. Date: Jul. 2, 2009

(54) STYRENE-BASED POLYMER, STYRENE-BASED COPOLYMER, RUBBER COMPOSITION AND PNEUMATIC TIRE

(76) Inventors: Koji Masaki, Tokyo (JP); Noriko Mori, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 11/568,999

(22) PCT Filed: Apr. 28, 2005
(86) PCT No.: PCT/JP05/08214

§ 371 Date: Nov. 13, 2006

(30) Foreign Application Priority Data
May 17, 2004 (JP) 2004-146468

(51) Int. Cl. C08L 9/06; C08F 12/08

(52) U.S. Cl. 525/232; 526/346

(57) ABSTRACT

This invention relates to a styrene-based (co)polymer capable of improving tan δ of a rubber composition while ensuring a fracture resistance of the rubber composition by adding to the rubber composition, and more particularly to a styrene-based polymer obtained by homopolymerizing a styrene derivative and having a weight average molecular weight as converted to polystyrene of 2×10³ to 50×10³, and a styrene-based copolymer obtained by copolymerizing styrene and at least one of styrene derivatives and having a weight average molecular weight as converted to polystyrene of 2×10³ to 50×10³.

### TECHNICAL FIELD

This invention relates to a styrene-based polymer, a styrene-based copolymer, a rubber composition comprising such a styrene-based (co)polymer and a pneumatic tire using such a rubber composition, and more particularly to a rubber composition capable of improving a steering stability of a tire while ensuring a fracture resistance such as a wear resistance or the like when it is used in a tire tread.

### BACKGROUND ART

Recently, a more excellent steering stability is required as a tire performance with a highly advance of engine performances in a passenger car. Particularly, it becomes an important issue to ensure the steering stability on a dry road surface as a performance required in a high-performance tire. Heretofore, various techniques are developed for satisfying the requirement on the improvement of the steering stability in these tires. In the development of rubber compositions for a tire tread directly contributing to the improvement of the steering stability of the tire, it is commonly effective to use loss tangent (tan δ) at a temperature above room temperature as an index. Concretely, the steering stability of the tire can be improved by using a rubber composition having a high tan δ above room temperature in the tread.

As a method of increasing tan δ of the rubber composition have hitherto been known a technique wherein a C₉ aromatic resin having a high glass transition point (Tg) is compounded into a rubber composition (see JP-A-H05-9338) and a technique wherein a liquid styrene-butadiene copolymer having several tens of thousands of molecular weight is compounded into a rubber composition (see JP-A-S61-203145). However, when the resin having the high glass transition point is compounded into the rubber composition, since the molecular weight of the resin is low, there is a problem that fracture characteristics of the rubber composition are deteriorated. Moreover, when the liquid styrene-butadiene copolymer is compounded into the rubber composition, since the glass transition point of the liquid copolymer is low, there is a problem that the tan δ of the rubber composition cannot be sufficiently improved.

On the other hand, it is an important issue to ensure the wear performance of the tire in view of economical efficiency. Also, when an additive such the resin, the liquid polymer or the like is compounded for improving the tan δ of the rubber composition, the additive to be compounded must have a sufficiently good compatibility with a rubber component in view of ensuring the fracture characteristics of the tire sufficiently.

### DISCLOSURE OF THE INVENTION

It is, therefore, an object of the invention to solve the above-mentioned problems of the conventional techniques and to provide a rubber composition capable of highly improving the steering stability of the tire while ensuring the fracture resistance. Also, it is another object of the invention to provide a styrene-based (co)polymer capable of improving the tan δ of the rubber composition while ensuring the fracture resistance of the rubber composition by adding to the rubber composition. Furthermore, it is the other object of the invention to provide a pneumatic tire using the rubber composition in a tread, in which the steering stability and the fracture resistance such as a wear resistance or the like are highly established.

The inventors have made various studies in order to achieve the above objects and discovered that the tan δ of the rubber composition can be highly improved but also the fracture resistance of the rubber composition can be ensured by compounding a styrene-based (co)polymer having a good compatibility with a rubber component, a high glass transition point and a relatively high molecular weight into the rubber composition, and the steering stability of the tire can be highly improved while ensuring the fracture resistance sufficiently by using the above rubber composition in the tread, and as a result the invention has been accomplished.

That is, the styrene-based polymer according to the invention is a styrene-based polymer obtained by homopolymerizing a styrene derivative, and is characterized in that a weight average molecular weight as converted to polystyrene is 2×10³ to 50×10³. Also, the styrene-based copolymer according to the invention is a styrene-based copolymer obtained by copolymerizing a styrene and at least one of styrene derivatives, and is characterized in that a weight average molecular weight as converted to polystyrene is 2×10³ to 50×10³. The term “styrene derivative” used herein means ones obtained by substituting a hydrogen in a styrene molecule with a monovalent substituent, which includes both the substitution of a hydrogen in a benzene ring of the styrene molecule and the substitution of a hydrogen of a vinyl group in the styrene molecule. The styrene derivative is preferable to be a derivative obtained through the substitution of the hydrogen in the benzene ring of the styrene molecule and is more preferable to be a derivative having a substituent at a para-position against the vinyl group. As the monovalent substituent are mentioned an alkyl group, a cycloalkyl group, an alkenyl group and the like.

In a preferable embodiment of the styrene-based (co)polymer according to the invention, at least one of the styrene derivatives has an alkyl group having a carbon number of 1 to 12 as a substituent in the benzene ring. Moreover, at least one of the styrene derivatives is more preferable to have an alkyl group having a carbon number of 1 to 8, and particularly preferable to have tert-butyl group as a substituent in the benzene ring.

Moreover, the styrene-based copolymer according to the invention may be one obtained by copolymerizing styrene and at least two of the styrene derivatives.

Also, the rubber composition according to the invention is characterized by comprising 5 to 150 parts by mass of the above styrene-based polymer or styrene-based copolymer based on 100 parts by mass of a rubber component composed of a diene-based rubber.

In a preferable embodiment of the rubber composition according to the invention, the rubber component comprises a copolymer of a conjugated diene compound and an aromatic vinyl compound having a weight average molecular weight as converted to polystyrene of 300×10³ to 3,000×10³. Moreover, a styrene-butadiene copolymer rubber (SBR) is preferable as the copolymer of the conjugated diene compound and the aromatic vinyl compound.

The rubber composition according to the invention is preferable to comprise 10 to 200 parts by mass of a styrene-butadiene copolymer having a weight average molecular weight as converted to polystyrene of 5.0×10³ to 2.0×10⁵ and a bound styrene content of 10 to 70% by mass based on 100 parts by mass of the rubber component.

Furthermore, the pneumatic tire according to the invention is characterized in that the above-described rubber composition is used in a tread.

According to the invention, there can be provided the styrene-based polymer and the styrene-based copolymer using the styrene derivative as a monomer and having a relatively high molecular weight, a good compatibility with the rubber component and a sufficiently high glass transition point. Also, there can be provided the rubber composition comprising such a styrene-based (co)polymer and having a high tan δ and sufficient fracture characteristics. Furthermore, there can be provided the pneumatic tire using such a rubber composition in the tread and having sufficient fracture characteristics and an excellent steering stability.

### BEST MODE FOR CARRYING OUT THE INVENTION

The invention will be described in detail below. The rubber composition according to the invention comprises 5 to 150 parts by mass of a styrene-based polymer obtained by homopolymerizing a styrene derivative and having a weight average molecular weight as converted to polystyrene of 2×10³ to 50×10³ or a styrene-based copolymer obtained by copolymerizing styrene and at least one of styrene derivatives and having a weight average molecular weight as converted to polystyrene of 2×10³ to 50×10³, based on 100 parts by mass of a rubber component composed of a diene-based rubber. Since the styrene-based (co)polymer has a high glass transition point, it can improve tan δ of the rubber composition. Also, since the styrene-based (co)polymer has a relatively high molecular weight and a relatively good compatibility with the rubber component, it can sufficiently ensure the fracture resistance of the rubber composition. Therefore, the rubber composition according to the invention comprising the styrene-based (co)polymer has a high tan δ and a sufficient fracture resistance, and the steering stability and the fracture characteristics of the tire can be highly established by using the rubber composition in the tire tread.

As the diene-based rubber used as the rubber component in the rubber composition according to the invention are mentioned natural rubber (NR) and synthetic rubbers such as a copolymer of a conjugated diene compound and an aromatic vinyl compound, e.g. styrene-butadiene copolymer rubber (SBR), styrene-isoprene copolymer rubber (SIR) or the like, a homopolymer of a conjugated diene compound, e.g. polyisoprene rubber (IR), polybutadiene rubber (BR) or the like, butyl rubber (IIR), ethylene-propylene copolymer, a mixture thereof and so on. Moreover, there may be used a diene-based rubber having a branch structure, in which a part thereof is modified with a polyfunctional modifying agent such as tin tetrachloride or the like. These diene-based rubbers may be used alone or in a blend of two or more.

Among the diene-based rubbers, the conjugated diene compound-aromatic vinyl compound copolymer is preferable and SBR is particularly preferable in view of compatibility of a commonly available ones. Moreover, the conjugated diene compound-aromatic vinyl compound copolymer is preferable to have a weight average molecular weight as converted to polystyrene of 300×10³ to 3,000×10³. When the conjugated diene compound-aromatic vinyl compound copolymer having a weight average molecular weight of less than 300×10³ is used, the fracture characteristics of the rubber composition tend to be lowered, while the conjugated diene compound-aromatic vinyl compound copolymer having a weight average molecular weight of more than 3,000×10³ is bad in the productivity because a viscosity of a polymerization solution becomes high. When SBR is used as the rubber component, it may be blended with NR, BR and the like, but it is preferable that the content of SBR in the rubber component is not less than 40% by mass.

The styrene-based polymer used in the rubber composition of the invention is obtained by homopolymerizing the styrene derivative and has the weight average molecular weight as converted to polystyrene of 2×10³ to 50×10³. Also, the styrene-based copolymer used in the rubber composition of the invention is obtained by copolymerizing styrene and at least one of the styrene derivatives and has the weight average molecular weight as converted to polystyrene of 2×10³ to 50×10³. When the weight average molecular weight of the styrene-based (co)polymer is less than 2×10³, the fracture characteristics of the rubber composition tend to be lowered, while when it exceeds 50×10³, the processability of the rubber composition tends to be deteriorated. Moreover, the performances of the tread become best by compounding the styrene-based (co)polymer having the weight average molecular weight as converted to polystyrene of 5×10³ to 50×10³ into the rubber composition and using such a rubber composition in the tread, although they are dependent upon the purpose.

The styrene-based (co)polymer is preferable to have a glass transition point of not lower than 70° C. When the styrene-based (co)polymer having a glass transition point of not lower than 70° C. is compounded into the rubber composition, the tan δ of the rubber composition can be improved sufficiently.

The styrene-based copolymer is preferable to be obtained by random copolymerization. The bound styrene content in the styrene-based copolymer is preferably not more than 90% by mass, more preferably not more than 50% by mass.

The styrene derivative as a starting monomer of the styrene-based (co)polymer is a derivative obtained by substituting a hydrogen in a styrene molecule with a monovalent substituent, and includes both a derivative obtained by the substitution of a hydrogen in a benzene ring of the styrene molecule and a derivative obtained by the substitution of a hydrogen in a vinyl group of the styrene molecule. Among the styrene derivatives, it is preferable to be a derivative obtained through the substitution of the hydrogen in the benzene ring of the styrene molecule and is more preferable to be a derivative having a substituent at a para-position against the vinyl group. As the monovalent substituent are mentioned an alkyl group such as methyl group, ethyl group, propyl group, isobutyl group, tert-butyl group or the like; a cycloalkyl group such as cyclohexyl group or the like; an alkenyl group such as vinyl group or the like; and so on. Among the styrene derivatives, a styrene derivative having an alkyl group with a carbon number of 1 to 12 as a substituent in the benzene ring is preferable, and a styrene derivative having an alkyl group with a carbon number of 1 to 8 as a substituent in the benzene ring is more preferable, and a styrene derivative having tert-butyl group as a substituent in the benzene ring is particularly preferable. As the styrene derivative are concretely mentioned alkyl styrenes such as methyl styrene, ethyl styrene, isobutyl styrene, tert-butyl styrene, a-methyl styrene, 2,4,6-trimethyl styrene and the like; cycloalkyl styrenes such as 4-cyclohexyl styrene and the like; and alkenyl styrenes such as divinyl benzene and the like. Among them, p-tert-butyl styrene is particularly preferable. In the styrene-based copolymer of the invention, at least one of the styrene derivatives must be used as a monomer, and two or more styrene derivatives may be used.

The styrene-based copolymer of the invention can be produced by a common polymerization method of olefins such as anionic polymerization using styrene and the styrene derivative as the monomer. Also, the styrene-based polymer of the invention can be produced by a common polymerization method of olefins such as anionic polymerization using the styrene derivative as the monomer. When the styrene-based (co)polymer is produced by the anionic polymerization, an organolithium compound is usually used as a polymerization initiator and each monomer is (co)polymerized in an inert organic solvent. Moreover, since the styrene-based copolymer is preferable to be randomly polymerized as previously mentioned, it is preferable to use a randomizer, if necessary.

As the organolithium compound used as the polymerization initiator are mentioned an alkyl lithium such as ethyl lithium, n-propyl lithium, i-propyl lithium, n-butyl lithium, sec-butyl lithium, tert-octyl lithium, n-decyl lithium or the like; an aryl lithium such as phenyl lithium, 2-naphthyl lithium, 2-butyl-phenyl lithium or the like; an aralkyl lithium such as 4-phenyl-butyl lithium or the like; a cycloalkyl lithium such as cyclohexyl lithium, 4-cyclopentyl lithium or the like; a lithium amide compound such as lithium hexamethylene imide, lithium pyrrolidide, lithium piperidide, lithium heptamethylene imide, lithium dodecamethylene imide, lithium dimethyl amide, lithium diethyl amide, lithium dipropyl amide, lithium dibutyl amide, lithium dihexyl amide, lithium diheptyl amide, lithium dioctyl amide, lithium di-2-ethylhexyl amide, lithium didecyl amide, lithium-N-methyl piperazide, lithium ethyl propyl amide, lithium ethyl butyl amide, lithium methyl butyl amide, lithium ethyl benzyl amide, lithium methyl phenethyl amide or the like; and so on. Among them, n-butyl lithium is preferable. The amount of the organolithium compound used is preferable to be within a range of 0.2 to 20 mmol per 100 g of the monomer.

As the inert organic solvent are mentioned an aliphatic hydrocarbon such as propane, n-butane, i-butane, n-pentane, i-pentane, n-hexane, propene, 1-butene, i-butene, trans-2-butene, cis-2-butene, 1-pentene, 2-pentene, 1-hexene, 2-hexene or the like; an aromatic hydrocarbon such as benzene, toluene, xylene, ethyl benzene or the like; and an alicyclic hydrocarbon such as cyclohexane or the like. Among them, cyclohexane is preferable. These inert organic solvents may be used alone or in a combination of two or more.

As the randomizer are mentioned dimethoxy benzene, tetrahydrofuran, dimethoxy ethane, diethylene glycol dibutyl ether, diethylene glycol dimethyl ether, bis tetrahydrofuryl propane, triethylamine, pyridine, N-methylmorpholine, N,N,N′,N′-tetramethylethylenediamine, 1,2-dipiperidinoethane, potassium-t-amylate, potassium-t-butoxide, sodium-t-amylate and so on. The amount of the randomizer used is preferable to be within a range of 0.01 to 20 mole per 1 mole of the organolithium compound as the polymerization initiator.

In the production of the styrene-based (co)polymer, the polymerization temperature is preferably within a range of about −80 to 150° C., more preferably within a range of about −20 to 100° C. Although the polymerization can be performed under a pressure generated, it is commonly preferable to be performed under a pressure enough to maintain the monomer used at substantially a liquid phase. Moreover, the pressure of the polymerization is dependent on raw materials used such as the monomer, the initiator and the like and the polymerization temperature, but the polymerization can be performed under a pressure higher than the pressure generated, if necessary. When the polymerization is performed under a pressure higher than the pressure generated, it is preferable to pressurize the polymerization system with an inert gas. Preferably, water, oxygen, carbon dioxide and other catalyst poisons are previously removed from all raw materials used for polymerization such as the monomer, the polymerization initiator, the solvent and the like.

In the rubber composition of the invention, the amount of the styrene-based (co)polymer compounded is 5 to 150 parts by mass based on 100 parts by mass of the rubber component. When the amount of the styrene-based (co)polymer compounded is less than 5 parts by mass based on 100 parts by mass of the rubber component, the effect of compounding the styrene-based (co)polymer is small and the tan δ of the rubber composition cannot be sufficiently improved, while when it exceeds 150 parts by mass, the breaking strength of the rubber composition is deteriorated.

The rubber composition is preferable to further contain 10 to 200 parts by mass of a styrene-butadiene copolymer having a weight average molecular weight as converted to polystyrene of 5.0×10³ to 2.0×10⁵ and a bound styrene content of 10 to 70% by mass based on 100 parts by mass of the rubber component. When the styrene-butadiene copolymer having the weight average molecular weight as converted to polystyrene of 5.0×10³ to 2.0×10⁵ and the bound styrene content of 10 to 70% by mass is compounded into the rubber composition, there can be improved the fracture characteristics, wear resistance and steering stability of the tire using such a rubber composition in the tread. When the weight average molecular weight as converted to polystyrene is less than 5.0×10³ or more than 2.0×10⁵, or when the bound styrene content is less than 10% by mass or more than 70% by mass, the steering stability may not be improved sufficiently. Moreover, when the amount of the styrene-butadiene copolymer compounded is less than 10 parts by mass, the effect of improving the steering stability and wear resistance of the tire is small, while when it exceeds 200 parts by mass, the Mooney viscosity of the rubber composition becomes too low and the productivity may be deteriorated. The styrene-butadiene copolymer can be produced according to a usual method by using styrene and 1,3-butadiene as a raw material.

The rubber composition of the invention is preferable to be compounded with a filler, not particularly limited, but is preferable to be compounded with carbon black and/or silica.

The silica is not particularly limited, but includes, for example, precipitated silica (hydrous silicate), fumed silica (anhydrous silicate), calcium silicate, aluminum silicate and so on. Among them, the precipitated silica is preferable in a point that the effect of improving fracture characteristics and the effect of establishing the wet gripping performance and the low rolling resistance are excellent. In the rubber composition of the invention, the silica may be only compounded as the filler. In this case, the amount of the silica compounded is 10 to 250 parts by mass based on 100 parts by mass of the rubber component, and preferably 20 to 150 parts by mass from a viewpoint of the reinforcing property and the improvement efficiency of various characteristics. When the amount of the silica compounded is less than 10 parts by mass based on 100 parts by mass of the rubber component, the fracture characteristics and the like are not sufficient, while when it exceeds 250 parts by mass, the processability of the rubber composition is deteriorated.

When the silica is used as the filler in the rubber composition of the invention, it is preferable that a silane coupling agent is added on compounding in view of further improving the reinforcing property. As the silane coupling agent are mentioned bis(3-triethoxysilylpropyl) tetrasulfide, bis(3-triethoxysilylpropyl) trisulfide, bis(3-triethoxysilylpropyl) disulfide, bis(2-triethoxysilylethyl) tetrasulfide, bis(3-trimethoxysilylpropyl) tetrasulfide, bis(2-trimethoxysilylethyl) tetrasulfide, 3-mercaptopropyltrimethoxy silane, 3-mercaptopropyltriethoxy silane, 2-mercaptoethyltrimethoxy silane, 2-mercaptoethyltriethoxy silane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropyl benzothiazole tetrasulfide, 3-triethoxysilylpropyl benzothiazole tetrasulfide, 3-triethoxysilylpropyl methacrylate monosulfide, 3-trimethoxysilylpropyl methacrylate monosulfide, bis(3-diethoxymethylsilylpropyl) tetrasulfide, 3-mercaptopropyl dimethoxymethyl silane, dimethoxymethylsilylpropyl-N,N-dimethylthiocarbamoyl tetrasulfide, dimethoxymethylsilylpropyl benzothiazole tetrasulfide and the like. Among them, bis(3-triethoxysilylpropyl) tetrasulfide and 3-trimethoxysilylpropyl benzothiazole tetrasulfide are preferable from a viewpoint of the effect of improving the reinforcing property. These silane coupling agents may be used alone or in a combination of two or more.

On the other hand, the carbon black is not particularly limited, but includes FEF, SRF, HAF, ISAF and SAF grade ones and the like. The carbon black preferably has an iodine adsorption number (IA) of not less than 60 mg/g and a dibutylphthalate (DBP) adsorption number of not less than 80 mL/100 g. Although the various characteristics of the rubber composition can be improved by compounding the carbon black, as the carbon black are more preferable HAF, ISAF and SAF grade carbon blacks in view of improving the wear resistance. In the rubber composition of the invention, the carbon black may be only compounded as the filler. In this case, the amount of the carbon black compounded is 10 to 250 parts by mass based on 100 parts by mass of the rubber component, and preferably 20 to 150 parts by mass from a viewpoint of the reinforcing property and the improvement efficiency of various characteristics. When the amount of the carbon black compounded is less than 10 parts by mass based on 100 parts by mass of the rubber component, the fracture characteristics and the like are not sufficient, while when it exceeds 250 parts by mass, the processability of the rubber composition is deteriorated.

A common crosslinking system for a rubber can be used in the rubber composition of the invention, and a combination of a crosslinking agent and a vulcanization accelerator is preferably used. As the crosslinking agent are mentioned sulfur and the like. The amount of the crosslinking agent used is preferable to be within a range of 0.1 to 10 parts by mass as a sulfur content, and more preferable to be within a range of 1 to 5 parts by mass based on 100 parts by mass of the rubber component. When the amount of the crosslinking agent compounded is 0.1 part by mass as the sulfur content based on 100 parts by mass of the rubber component, the breaking strength, wear resistance and low heat build-up of the resulting vulcanized rubber are deteriorated, while when it exceeds 10 parts by mass, the rubber elasticity is lost.

On the other hand, the vulcanization accelerator is not particularly limited, but includes a thiazole-based vulcanization accelerator such as 2-mercaptobenzothiazole (M), dibenzothiazyl disulfide (DM), N-cyclohexyl-2-benzothiazyl sulfenamide (CZ), N-t-butyl-2-benzothiazolyl sulfenamide (NS) or the like; a guanidine-based vulcanization accelerator such as diphenyl guanidine (DPG) or the like; and so on. The amount of the vulcanization accelerator used is preferably within a range of 0.1 to 5 parts by mass, more preferably within a range of 0.2 to 3 parts by mass based on 100 parts by mass of the rubber component. These vulcanization accelerators may be used alone or in a combination of two or more.

A processing oil or the like can be used as a softener in the rubber composition of the invention. As the processing oil are mentioned a paraffinic oil, a naphthenic oil, an aromatic oil and the like. Among them, the aromatic oil is preferable in view of the tensile strength and wear resistance, and the naphthenic oil and the paraffinic oil are preferable in view of the hysteresis loss and low-temperature characteristics. The amount of the processing oil used is preferable to be within a range of 0 to 100 parts by mass based on 100 parts by mass of the rubber component. When the amount of the processing oil used exceeds 100 parts by mass based on 100 parts by mass of the rubber component, the tensile strength and low heat build-up of the vulcanized rubber tend to be deteriorated.

In the rubber composition of the invention can be compounded additives usually used in the rubber industry such as an anti-aging agent, zinc oxide, stearic acid, an antioxidant, an antiozonant and the like within a scope of not damaging the object of the invention in addition to the rubber component, the styrene-based (co)polymer, the filler such as carbon black, silica or the like, the silane coupling agent, the crosslinking agent, the vulcanization accelerator and the softener.

The rubber composition of the invention is obtained by milling with a milling machine such as rolls, an internal mixer or the like, which can be shaped and vulcanized for use in tire applications such as a tread, an under tread, a carcass, a sidewall, a bead and the like as well as a rubber cushion, a belt, a hose and other industrial products, but it is particularly suitable for use in the tire tread.

The pneumatic tire according to the invention is characterized by using the above rubber composition in a tread. The tire has an excellent steering stability and a good fracture resistance because the aforementioned rubber composition having a high tan δ and good fracture characteristics is applied to the tread of the tire. The pneumatic tire according to the invention is not particularly limited as far as the above rubber composition is used for the tread, and can be produced by the usual method. Moreover, as a gas filled into the tire can be used usual air or air having a regulated partial oxygen pressure but also inert gases such as nitrogen, argon, helium and so on.

### EXAMPLES

The following examples are given in illustration of the invention and are not intended as limitations thereof.

### Synthesis Example 1

Into a stainless pressure reactor having a volume of 2 L dried and purged with nitrogen and provided with a temperature-controlling jacket are charged 500 g of cyclohexane, 70 g of p-tert-butyl styrene and 30 g of styrene which are previously dried. After the temperature in the reactor is adjusted to 40° C. by controlling the jacket temperature, 5 mmol of bis tetrahydrofuryl propane is added and a solution of n-butyl lithium (n-BuLi) in hexane (n-BuLi: 10 mmol) id further added to conduct the polymerization reaction. While the temperature is controlled so that the temperature of the polymerization system becomes 75° C. after 25 minutes, the polymerization reaction is continued. After the temperature of the polymerization system is further maintained for 15 minutes, 0.5 mL of a solution of 2,6-di-tert-butyl-p-cresol (BHT) in isopropanol (BHT concentration=5%) is added to the polymerization system to stop the polymerization reaction, and a styrene-based copolymer A is obtained by drying according to a usual method. The resulting polymer has a p-tert-butyl styrene unit of 70% and a styrene unit of 30%, in which styrene is bonded randomly. As the molecular weight is measured through a gel permeation chromatography [GPC: HLC-8020 manufactured by TOSOH, column: GMH-XL manufactured by TOSOH (series of two columns), detector: differential refractometer (RI)] based on a monodisperse polystyrene standard, the resulting styrene-based copolymer A is confirmed to have a weight average molecular weight (Mw) s converted to polystyrene of 10×10³. Moreover, the styrene-based copolymer A has a glass transition point of 120° C.

### Synthesis Example 2

A styrene-based copolymer B is obtained in the same manner as in the synthesis example 1 except that p-methyl styrene is used instead of p-tert-butyl styrene and a mass ratio of p-methyl styrene/styrene and a mass ratio of a total monomer amount/n-BuLi are changed (although a molar ratio of bis tetrahydrofuryl propane/n-BuLi is fixed to 0.5). The resulting polymer has a p-methyl styrene unit of 50% by mass and a styrene unit of 50% by mass, in which the styrene is bonded randomly. Also, the styrene-based copolymer B has a weight average molecular weight (Mw) as converted to polystyrene of 10×10³ and a glass transition point of 105° C.

Then, a rubber composition having a compounding recipe as shown in Tables 1 and 2 is prepared according to a usual method by using the above styrene-based copolymer, and then the fracture resistance and steering stability of the resulting rubber composition are evaluated by the following methods. The results are shown in Tables 1 and 2.

(1) Fracture Resistance

A tensile test is conducted according to JIS K 6301-1995 to measure a tensile strength (Tb) of a vulcanized rubber composition, which is shown in Table 1 by an index on the basis that the tensile strength of Comparative Example 1 is 100, and in Table 2 by an index on the basis that the tensile strength of Comparative Example 4 is 100. The larger the index value, the better the fracture resistance.

(2) Steering Stability

Tan δ is measured at a shear strain of 5%, a temperature of 60° C. and a frequency of 15 Hz by using a mechanical spectrometer manufactured by RHEOMETRICS Corporation, which is shown in Table 1 by an index on the basis that the tan δ of the comparative Example 1 is 100, and in Table 2 by an index on the basis that the tan δ of the comparative Example 4 is 100. The larger the index value, the larger the hysteresis loss and the better the steering stability.

TABLE 1

| | | | Comparative | Comparative | Comparative | Example | Example | Example | Example |
|---|---|---|---|---|---|---|---|---|---|
| | | | Example 1 | Example 2 | Example 3 | 1 | 2 | 3 | 4 |
| Formulation | SBR(A) *1 | parts by | 100 | 100 | 100 | 100 | 100 | 100 | 100 |
| | Carbon black *2 | mass | 65 | 65 | 65 | 65 | 65 | 65 | 65 |
| | Stearic acid | | 2 | 2 | 2 | 2 | 2 | 2 | 2 |
| | Zinc white | | 3 | 3 | 3 | 3 | 3 | 3 | 3 |
| | Antioxidant 6C *3 | | 1 | 1 | 1 | 1 | 1 | 1 | 1 |
| | Vulcanization accelerator D *4 | | 0.4 | 0.4 | 0.4 | 0.4 | 0.4 | 0.4 | 0.4 |
| | Vulcanization accelerator NS *5 | | 1 | 1 | 1 | 1 | 1 | 1 | 1 |
| | Sulfur | | 1.75 | 1.75 | 1.75 | 1.75 | 1.75 | 1.75 | 1.75 |
| | Aromatic oil | | 20 | 20 | 20 | 20 | 20 | 20 | 20 |
| | Liquid SBR *6 | | — | 15 | — | — | — | 15 | 15 |
| | C₉ aromatic petroleum resin *7 | | — | — | 15 | — | — | — | — |
| | Styrene-based copolymer A *8 | | — | — | — | — | 15 | — | 15 |
| | Styrene-based copolymer B *9 | | — | — | — | 15 | — | 15 | — |
| Properties | Fracture resistance (Tb) | index | 100 | 102 | 92 | 97 | 102 | 100 | 102 |
| | Steering stability (tan δ at 60° C.) | | 100 | 105 | 113 | 119 | 123 | 123 | 126 |

*1 SBR1500 made by JSR Corporation, styrene content = 23.5% by mass, vinyl bond content = 18%, weight average molecular weight as converted to polystyrene = 444 × 10³.
*2 ISAF, SEAST 3H made by TOKAI CARBON CO., LTD.
*3 N-(1,3-dimethylbutyl)-N′-phenyl-p-phenylenedamine, “NOCRAC 6C” made by OUCHISHINKO CHEMICAL INDUSTRIAL CO., LTD.
*4 1,3-diphenyl guanidine, “NOCCELER D” made by OUCHISHINKO CHEMICAL INDUSTRIAL CO., LTD.
*5 N-t-butyl-2-benzothiazolyl sulfenamide, “NOCCELER NS” made by OUCHISHINKO CHEMICAL INDUSTRIAL CO., LTD.
*6 Liquid styrene-butadiene copolymer, styrene content = 20% by mass, vinyl bond content = 65%, weight average molecular weight as converted to polystyrene = 10 × 10³.
*7 NEOPOLYMER 140 (trade mark) made by NIPPON PETROCHEMICALS CO., LTD, weight average molecular weight as converted to polystyrene = 2 × 10³.
*8 Styrene-based copolymer A obtained in Synthesis Example 1.
*9 Styrene-based copolymer B obtained in Synthesis Example 2.

TABLE 2

| | | | Comparative | Comparative | Comparative | Example | Example | Example | Example |
|---|---|---|---|---|---|---|---|---|---|
| | | | Example 4 | Example 5 | Example 6 | 5 | 6 | 7 | 8 |
| Formulation | SBR (B) *10 | parts by | 100 | 100 | 100 | 100 | 100 | 100 | 100 |
| | Carbon black *2 | mass | 65 | 65 | 65 | 65 | 65 | 65 | 65 |
| | Stearic acid | | 2 | 2 | 2 | 2 | 2 | 2 | 2 |
| | Zinc white | | 3 | 3 | 3 | 3 | 3 | 3 | 3 |
| | Antioxidant 6C *3 | | 1 | 1 | 1 | 1 | 1 | 1 | 1 |
| | Vulcanization accelerator D *4 | | 0.4 | 0.4 | 0.4 | 0.4 | 0.4 | 0.4 | 0.4 |
| | Vulcanization accelerator NS *5 | | 1 | 1 | 1 | 1 | 1 | 1 | 1 |
| | Sulfur | | 1.75 | 1.75 | 1.75 | 1.75 | 1.75 | 1.75 | 1.75 |
| | Aromatic oil | | 20 | 20 | 20 | 20 | 20 | 20 | 20 |
| | Liquid SBR *6 | | — | 15 | — | — | — | 15 | 15 |
| | C₉ aromatic petroleum resin *7 | | — | — | 15 | — | — | — | — |
| | Styrene-based copolymer A *8 | | — | — | — | — | 15 | — | 15 |
| | Styrene-based copolymer B *9 | | — | — | — | 15 | — | 15 | — |
| Properties | Fracture resistance (Tb) | index | 100 | 101 | 93 | 98 | 103 | 100 | 97 |
| | Steering stability (tan δ at 60° C.) | | 100 | 104 | 115 | 121 | 129 | 123 | 131 |

*2 to *9 The same meanings as in Table 1.
*10 SBR synthesized by solution polymerization, styrene content = 38% by mass, vinyl bond content = 35%, weight average molecular weight as converted to polystyrene = 400 × 10³.

As seen from the results of Comparative Examples 2 and 5 in Tables 1 and 2, the steering stability can be improved while improving the fracture resistance of the rubber composition by compounding the liquid SBR, but the degree of improving the steering stability is small. Also, As seen from the results of Comparative Examples 3 and 6, the steering stability can be improved by compounding the C₉ aromatic petroleum resin, but the fracture resistance is highly deteriorated.

On the other hand, as seen from the results of Examples 1 to 8, the steering stability can be highly improved while ensuring the fracture resistance of the rubber composition by compounding the copolymer of the styrene and the styrene derivative. Moreover, as seen from the results of Examples 2 and 6, in case of compounding the copolymer of styrene and p-tert-butyl styrene, the steering stability of the rubber composition can be highly improved but also the fracture resistance of the rubber composition can be improved, so that the styrene-based copolymer obtained by using as a monomer the styrene derivative having tert-butyl group as the substituent in the benzene ring is particularly excellent among the styrene-based copolymers.

1. A styrene-based polymer obtained by homopolymerizing a styrene derivative, characterized in that a weight average molecular weight as converted to polystyrene is 2×10³ to 50×10³.

2. A styrene-based copolymer obtained by copolymerizing styrene and at least one of styrene derivatives, characterized in that a weight average molecular weight as converted to polystyrene is 2×10³ to 50×10³.

3. A styrene-based (co)polymer according to claim 1, wherein at least one of the styrene derivatives has an alkyl group having a carbon number of 1 to 12 as a substituent in a benzene ring.

4. A styrene-based (co)polymer according to claim 3, wherein at least one of the styrene derivatives has an alkyl group having a carbon number of 1 to 8 as a substituent in the benzene ring.

5. A styrene-based (co)polymer according to claim 4, wherein at least one of the styrene derivatives has tert-butyl group as a substituent in the benzene ring.

6. A styrene-based copolymer according to claim 2, which is obtained by copolymerizing styrene and at least two of the styrene derivatives.

7. A rubber composition comprising 5 to 150 parts by mass of a styrene-based (co)polymer as claimed in claim 1 based on 100 parts by mass of a rubber component composed of a diene-based rubber.

8. A rubber composition according to claim 7, wherein the rubber component comprises a copolymer of a conjugated diene compound and an aromatic vinyl compound having a weight average molecular weight as converted to polystyrene of 300×10³ to 3,000×10³.

9. A rubber composition according to claim 8, wherein the copolymer of the conjugated diene compound and the aromatic vinyl compound is a styrene-butadiene copolymer rubber.

10. A rubber composition according to claim 7, which comprises 10 to 200 parts by mass of a styrene-butadiene copolymer having a weight average molecular weight as converted to polystyrene of 5.0×10³ to 2.0×10⁵ and a bound styrene content of 10 to 70% by mass based on 100 parts by mass of the rubber component.

11. A pneumatic tire, characterized in that a rubber composition as claimed in claim 7 is used in a tread.
